(19) United States
(12) Patent Application Publication
(10) Pub. No.: US 2014/0252638 A1
(43) Pub. Date: Sep. 11, 2014

(54) VERTICAL INTERCONNECTS CROSSTALK OPTIMIZATION

(71) Applicant: QUALCOMM Incorporated, San Diego, CA (US)

(72) Inventors: Shree Krishna Pandey, San Diego, CA (US); Changyu Sun, San Diego, CA (US)

(21) Appl. No.: 13/935,940

(22) Filed: Jul. 5, 2013

Related U.S. Application Data
(60) Provisional application No. 61/775,057, filed on Mar. 8, 2013.

(51) Int. Cl. G06F 17/50

(52) U.S. Cl. CPC G06F 17/5081
USPC 257/773; 716/132

(57) ABSTRACT

A method, an apparatus, and a computer program product for wireless communication are provided. The apparatus generate a plurality of interconnect patterns for a set of vertical interconnects. Each interconnect pattern may be different from the other interconnect patterns. Each interconnect pattern may define relative locations for the set of vertical interconnects within a predefined area of a substrate in the semiconductor device. Highest crosstalk is determined for each of the interconnect patterns and the interconnect pattern with the minimum highest crosstalk is selected as a preferred pattern. One or more sets of interconnects is formed on a substrate in accordance with the preferred pattern. At least one set of interconnects may be rotated with respect to another set of interconnects on the substrate to minimize crosstalk between the sets of interconnects.

### CROSS-REFERENCE TO RELATED APPLICATIONS

This application claims priority to and the benefit of U.S. Provisional Application No. 61/775,057 titled “Vertical Interconnects Crosstalk Optimization” filed on Mar. 8, 2013, the entire content of which is incorporated herein by reference.

### BACKGROUND

1. Field

Various features relate generally to apparatus comprising integrated circuit devices and more particularly to optimizing patterns of interconnects used to connect devices within the apparatus.

2. Background

In higher speed semiconductor integrated circuit (IC) devices, vertical interconnect assignments and patterns can play a critical role in signal integrity and can limit achievable maximum frequencies associated with the semiconductor device. Vertical interconnects may comprise interconnects using solder balls, solder bumps and vias. Signaling rates continue to increase to obtain performance improvements in certain classes of high-speed semiconductor devices. In one example, the Joint Electron Devices Engineering Council (JEDEC) standards for consecutive generations of synchronous dynamic random-access memory (SDRAM), including double data rate (DDR) SDRAM typically provide for increases in speed for later generations. One generation of Low Power DDR (LPDDR) SDRAM defined by JEDEC may provide for speeds that are double the speed of one or more preceding generations of LPDDR. Crosstalk between adjacent interconnects increases as signaling rates increase.

Conventionally, semiconductor designers employ intuitive insight in designing interconnect assignments and patterns in high-speed semiconductor devices. This design process is typically iterative and time-consuming, and often yields less than optimal results. Conventional methods for bump pattern optimization are not scalable and/or require a-priori knowledge. For instance, some prior art approaches focus on a very small problem size (up to 2 signals only) and cannot generally be scaled to larger interconnect patterns (e.g., to a full DDR interface design). Conventional approaches do not account for variable numbers of signal and power/ground interconnects. In some conventional systems, a-priori knowledge is required including, for example, a-priori knowledge of an inductance matrix in an interconnect pattern when optimizing for simultaneous switching noise.

Therefore, a solution is needed that optimizes interconnect patterns for minimum crosstalk for an arbitrary number of signal and power/ground interconnects.

### SUMMARY

In an aspect of the disclosure, a method, a computer program product, and an apparatus are provided for optimizing interconnect patterns in a semiconductor device.

In an aspect of the disclosure, a plurality of interconnect patterns is generated for a set of vertical interconnects. Each interconnect pattern may be different from the other interconnect patterns. Each interconnect pattern may define relative locations for the set of vertical interconnects within a predefined area of a substrate in the semiconductor device.

In an aspect of the disclosure, a highest crosstalk is determined for each of the interconnect patterns. The highest crosstalk for each interconnect pattern may correspond to one of the set of vertical interconnects. A preferred interconnect pattern may be selected from the plurality of interconnect patterns. The preferred interconnect pattern may provide a lower highest crosstalk than the highest crosstalk associated with each of the other interconnect patterns.

In an aspect of the disclosure, the set of vertical interconnects includes a first plurality of interconnects configured to transmit signals between first and second layers of the semiconductor device, and a second plurality of interconnects configured to interconnect ground planes of the first and second layers, or power supplies of the first and second layers.

In an aspect of the disclosure, the set of vertical interconnects includes 16 interconnects. The 16 interconnects may be arranged in a 4 by 4 interconnect pattern. The set of interconnects may include more than 16 interconnects and may be arranged in an A×A, or A×B array, where an A×A array may comprise a 5×5 array, for example. The number of interconnect patterns generated may be determined as a function of the number of first plurality of interconnects.

In an aspect of the disclosure, the set of vertical interconnects are evenly distributed within the predefined area. The plurality of interconnect patterns may include all permutations of placement of the first plurality of interconnects within the predefined area.

In an aspect of the disclosure, the highest crosstalk for each of the interconnect patterns may be determined for a plurality of frequencies. The highest crosstalk for each of the interconnect patterns may be determined for a range of frequencies.

In an aspect of the disclosure, a set of interconnects may be formed at one or more locations on a surface of a substrate. The set of interconnects formed in each location may be formed in accordance with the preferred interconnect pattern. A plurality of sets of interconnects may be provided at different locations on the surface of the substrate. At least one set of interconnects may be rotated with respect to another set of interconnects.

In an aspect of the disclosure, the highest crosstalk for each of the interconnect patterns is determined by determining the highest crosstalk between two or more of the plurality of sets of interconnects. At least one set of interconnects may be rotated to obtain a minimum highest crosstalk between the two or more sets of interconnects.

In an aspect of the disclosure, the highest crosstalk for each of the interconnect patterns is determined by modeling the set of vertical interconnects as a plurality of cylindrical interconnects between two infinite planes, and calculating crosstalk between pairs of the cylindrical interconnects. Crosstalk may be calculated by calculating crosstalk between each pair of the cylindrical interconnects when both cylindrical interconnects correspond to vertical interconnects configured to transmit signals between first and second layers of the semiconductor device, and refraining from calculating crosstalk between the each pair of the cylindrical interconnects when one of the cylindrical interconnects corresponds to a vertical interconnects configured to interconnect ground planes of the first and second layers, or power supplies of the first and second layers.

In an aspect of the disclosure, the set of vertical interconnects may be formed at one or more locations on the surface of a substrate, chip carrier and/or circuit board by determining a location and orientation of the set of vertical interconnects with respect to one or more horizontal interconnects such that a highest crosstalk calculated for the set of vertical interconnects and the one or more horizontal interconnects is minimized.

In an aspect of the disclosure, an apparatus for optimizing interconnect patterns in a semiconductor device comprises a processor-readable storage medium and a processing system configured to generate a plurality of interconnect patterns for a set of vertical interconnects, determine a highest crosstalk for each interconnect pattern, and select a preferred interconnect pattern from the plurality of interconnect patterns. The preferred interconnect pattern may provide a lower highest crosstalk than the highest crosstalk associated with each of the other interconnect patterns. Each interconnect pattern may be different from the other interconnect patterns. Each interconnect pattern may define relative locations for the set of vertical interconnects within a predefined area. The highest crosstalk for each interconnect pattern may correspond to one of the set of vertical interconnects.

In an aspect of the disclosure, an apparatus for optimizing interconnect patterns in a semiconductor device includes means for generating a plurality of interconnect patterns for a set of vertical interconnects, means for determining a highest crosstalk for each interconnect pattern, and means for selecting a preferred interconnect pattern from the plurality of interconnect patterns. The preferred interconnect pattern may provide a lower highest crosstalk than the highest crosstalk associated with each of the other interconnect patterns. Each interconnect pattern may be different from the other interconnect patterns. Each interconnect pattern may define relative locations for the set of vertical interconnects within a predefined area. The highest crosstalk for each interconnect pattern may correspond to one of the set of vertical interconnects.

In an aspect of the disclosure, a processor-readable storage medium has one or more instructions which when executed by at least one processing circuit causes the at least one processing circuit to generate a plurality of interconnect patterns for a set of vertical interconnects between layers of a substrate, chip carrier or circuit board, determine a highest crosstalk for each interconnect pattern, and select a preferred interconnect pattern from the plurality of interconnect patterns. Each interconnect pattern may be different from the other interconnect patterns. Each interconnect pattern may define relative locations for the set of vertical interconnects within a predefined area. The highest crosstalk for each interconnect pattern may correspond to one of the set of vertical interconnects.

In an aspect of the disclosure, a semiconductor device includes a substrate, first and second layers provided on the substrate, and a plurality of interconnects formed between the first and second layers, whereby the interconnect pattern is selected from a plurality of interconnect patterns when a maximum crosstalk power estimated or calculated for the interconnect pattern is lower than maximum crosstalk powers estimated or calculated for the other interconnect patterns. The interconnect pattern may provide a lower highest crosstalk than the highest crosstalk associated with each of the other interconnect patterns. Each interconnect pattern may be different from the other interconnect patterns. Each interconnect pattern may define relative locations for the set of vertical interconnects within a predefined area. The highest crosstalk for each interconnect pattern may correspond to one of the set of vertical interconnects.

### BRIEF DESCRIPTION OF THE DRAWINGS

FIG. 1 illustrates a die and flip-chip assembly.

FIG. 2 is a diagram illustrating an example of a process used for optimizing an interconnect pattern to reduce crosstalk.

FIG. 3 is a graphical representation of near-end crosstalk corresponding to a plurality of interconnect patterns across a range of frequencies.

FIG. 4 illustrates a first example of vertical interconnects formed on a substrate using variants on an optimized interconnect pattern.

FIG. 5 illustrates a second example of vertical interconnects formed on a substrate using variants on an optimized interconnect pattern.

FIG. 6 illustrates a third example of vertical interconnects formed on a substrate using variants on an optimized interconnect pattern.

FIG. 7 illustrates the scalability of an optimized interconnect pattern.

FIG. 8 illustrates the formation of vertical interconnects in the presence of horizontal interconnects.

FIG. 9 illustrates signal fan-out from vertical interconnects.

FIG. 10 is a flowchart of a method for optimizing an interconnect pattern to reduce crosstalk.

FIG. 11 is a block diagram of an apparatus configured for optimizing an interconnect pattern to reduce crosstalk.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure.

As the demand for high performance devices implementing IC technology has increased so has the demand for increased functionality, speed, and portability of the devices. In connection with increasing performance and functionality of consumer electronics, maximum functional integration of the IC devices in an assembly having the smallest footprint, lowest profile, and lowest cost is desired. However, as functionality increases, the number of IC and passive electrical components in the assembly increases dramatically, thus threatening the objective of a smaller-sized assembly due to issues related to the frequencies, density and proximity of interconnecting signals within and between ICs. In one example, inductive and capacitive coupling between such higher density interconnects may be increased, leading to greater crosstalk between interconnecting signals.

In one example, interfaces associated with double data rate synchronous dynamic random-access memory (DDR SDRAM) devices commonly have bit widths that are multiples of 8 bits, including 16 bits, 32 bits, 64 bits, etc., and may support data rates that are at least double the data rates of core logic of the DDR SDRAM IC. The high data rates and demands for particular physical alignment of inputs and outputs (I/Os) create serious challenges to SDRAM designers and designers of other types of IC. Moreover, SDRAM devices typically have interfaces that are aligned with a desired physical assignment of I/O, and which may relate to a physical layout of a ball grid array (BGA), or copper pillar bumps of an IC. Examples of physical interfaces associated with SDRAM may be found on devices such as System-on-Chip (SoC) and Mobile Station Modem (MSM) integrated circuits. Such devices may include one or more processing subsystems and peripheral I/O such as radio transceivers, and may require large numbers of interface connections to external circuits. Accordingly, densities of arrays of solder balls, bumps and pillars are continuously increasing while operating frequencies of the devices are also increasing.

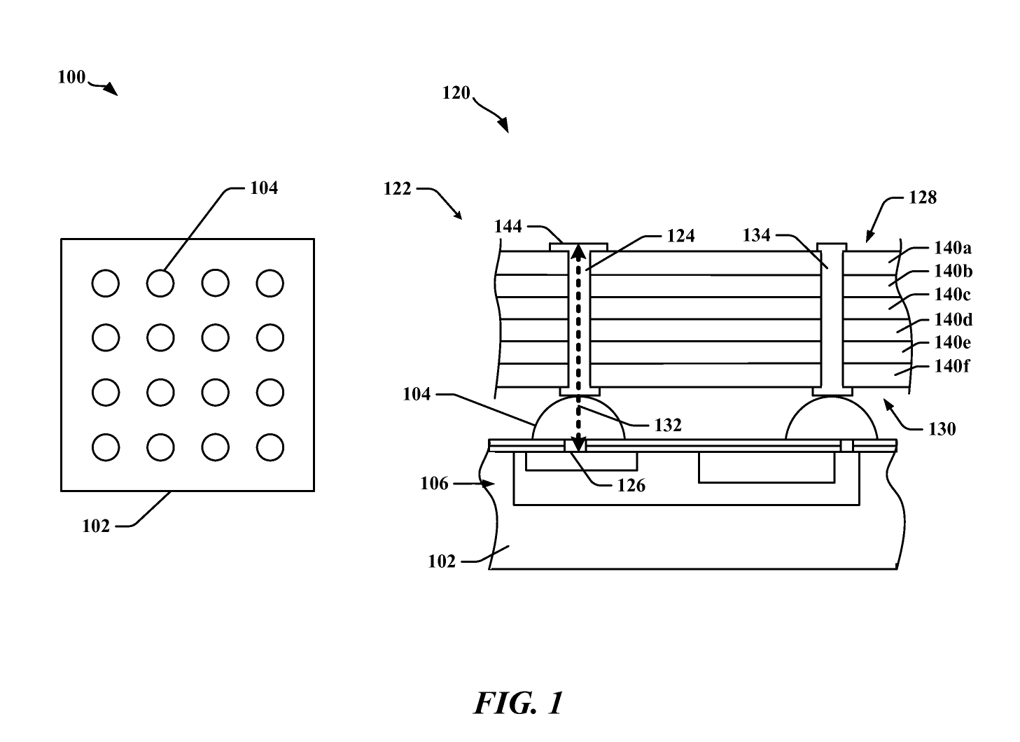

FIG. 1 illustrates a die 100 and flip-chip assembly 120 used for interconnecting an IC 106 provided on die 102 to external circuitry using solder bumps, balls or posts 104 that have been deposited onto an upper surface of the die 102. Solder bumps 104, or solder balls or posts may be formed during wafer processing to enable the die to be mounted to a circuit or chip carrier 122. In one example, chip-carrier 122 comprises a plurality of non-conductive layers 140a-140f, each non-conductive layer 140a-140f separating a pair of conductive layers in which circuit traces can be formed to interconnect inputs and outputs of the IC 106 with other devices, including other devices provided on the chip-carrier 122. A chip-carrier 122 may provide one or more pads 144 used to connect the flip-chip assembly 120 to external circuitry (e.g., a circuit board or another chip or wafer). A chip-carrier 122 may provide electrical connections between two or more dice 102 mounted on the chip-carrier 122. For example, connections may be made through circuits provided on a first surface 128 of the chip-carrier 122, where the first surface 128 is located on an opposite side of chip-carrier 122 from a second surface 130 of chip-carrier 122 that receives the solder bumps, balls or posts 104. Vias 124, 134 may be provided through layers 140a-140f of the chip-carrier 122 to connect circuitry and/or pads 144 on the first surface 128 to die 102 through solder bump/ball 104. Vias 124 and 134 may interconnect circuits provided on the surfaces of one or more of the layers 140a-140f. The die may also comprise vias 126 that connect the solder bumps 104 to circuitry 106 formed in one or more layers of a semiconductor substrate provided on die 102.

One or more of vias 124, 126 and solder bump 104 may be substantially in vertical alignment, thereby by forming a vertical interconnect, represented as line 132. The relative contributions of vias 124, 126 and solder bump, ball or post 104 to the physical length of the vertical interconnect 132 may vary with application. Capacitive, inductive and/or resistive coupling between adjacent vertical interconnects can introduce crosstalk between circuits within the flip-chip assembly 120.

In an aspect of the disclosure, a method, a system and an algorithm are provided that may be employed to optimize interconnect patterns in order to minimize crosstalk for an arbitrary number of signals and power/ground interconnects in semiconductor devices. For example, the interconnect pattern may comprise a pattern of bumps, vias, and/or cylindrical interconnects extending vertically through or from a substrate. Crosstalk may be defined as any undesirable effect generated in a first interconnect or other circuit by transmission of a signal through a second interconnect or other circuit. Crosstalk is typically observed as a result of parasitic or stray capacitive, inductive, or conductive coupling from the first interconnect or circuit to the second interconnect or circuit.

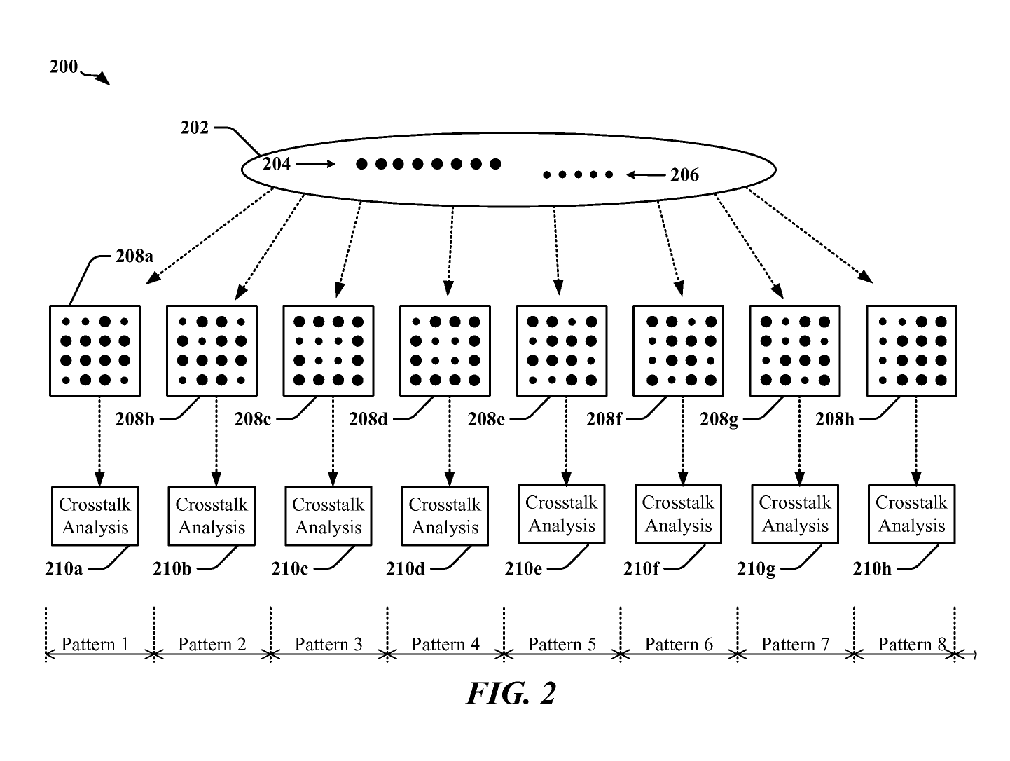

FIG. 2 is a diagram 200 illustrating one example of a process used for optimizing an interconnect pattern to reduce crosstalk according to certain aspects of the invention. A set of vertical interconnects 202 may intersect a predefined physical area of at least one layer of an IC, and/or chip-carrier. The set of interconnects 202 may be formed on a substrate, where the location of each vertical interconnect (interconnect site) within a predefined area of the substrate is controlled in accordance with one of a set of interconnect patterns, including the illustrated interconnect patterns 208a-208h. In the example depicted, the set of interconnects 202 includes a total of N interconnects and/or interconnect sites, including K signal interconnects 204 and P ground/power interconnects 206. For the sole purpose of facilitating description, these ground/power interconnects 206 are represented using smaller circles than the circles used to depict the signal interconnects 204. However, the physical size of individual ones of the signal interconnects 204 and/or individual ones of the ground/power interconnects 206 may be similar or different with respect to other ones of the signal interconnects 204 and/or other ones of the ground/power interconnects 206 according to application needs.

The values of N, K, and P may be variable and may be defined based on the specific requirements of an IC design. Typically, N=K+P. However, it is possible that one or more potential vertical interconnect sites are vacant or left unconnected at one or both ends, and that the value of N is accordingly greater than the sum of the K signal interconnects 204 and P ground/power interconnects 206.

To facilitate this disclosure, an example associated with an 8-bit data path is described, where the 8-bit data path may be a portion of a 24, 32, 64, or 72-bit data path corresponding to an SDRAM interface, for example. In the example shown in FIG. 2, the interconnects 202 may be provided at a total of N=16 vertical interconnect sites, of which the signal interconnects 204 occupy 11 interconnect sites, and the ground/power interconnects 206 occupies 5 interconnect sites. In the example, interconnect patterns may be generated for use in an SDRAM interface, and each interconnect pattern may be configured for interconnecting a subset of a data path. Accordingly, each interconnect pattern may facilitate the interconnection of 8 data signals (i.e. 1 byte) and 3 associated clock and/or control signals, in addition to power and ground connections. One or more interconnect patterns may be replicated multiple times on a substrate to match the width of the I/O data path of an SDRAM, for example.

In certain embodiments, all possible interconnect patterns are generated for a given combination of N, K, and P. It may be assumed that ground/power interconnects 206 do not generate or contribute significantly to crosstalk, and/or that the effect of ground/power interconnects 206 on crosstalk generation within the set of vertical interconnects 202 is negligible. Accordingly, a number of permutations of the possible patterns may be reduced by designating as duplicate patterns, two or more patterns which are distinguished only by location variations among the ground/power interconnects 206. In the example in which the signal interconnects 204 include 11 signals and the ground/power interconnects 206 include 5 ground/power interconnects, the number P of possible interconnect patterns may be calculated as:

$$P = ( \begin{matrix}16 \\ 5\end{matrix} ) = 4 , 368.$$

In some embodiments, all 4,368 possible interconnect patterns are generated and the crosstalk associated with each of the 4,368 possible interconnect patterns may be determined. In some instances, the number of interconnect patterns examined may be fewer than 4,368. For example, the ground/power interconnects 206 may be treated as having near identical effect on crosstalk and certain interconnect patterns may be eliminated from analysis when two or more interconnect patterns differ only in the arrangement of individual ones of the ground/power interconnects 206, such that the arrangement of the signal interconnects 204 with respect to one another is identical within the two or more interconnect patterns.

Different arrangements and/or locations of the signal interconnects 204 within the possible different interconnect patterns may result in different crosstalk effects within and between interconnect patterns. In one example, the arrangement of the ground/power interconnects 206 may beneficially screen one or more of the signal interconnects 204, thereby reducing crosstalk between certain of the signal interconnects 204. FIG. 2 illustrates eight interconnect patterns 208a-208h of the possible 4,368 interconnect patterns in order to facilitate description of certain aspects of the invention. For clarity of description, the eight interconnect patterns 208a-208h may be referred to herein as candidate patterns 208a-208h although any portion, or all of the 4,368 possible interconnect patterns may be candidates that are analyzed for crosstalk performance. The near-end crosstalk (NEXT) associated with each of the candidate patterns 208a-208h may be analyzed to produce a NEXT analysis 210a-210h for each candidate pattern 208a-208h. Crosstalk associated with each candidate pattern 208a-208h may be determined by calculating and/or estimating crosstalk between each pair of signal interconnects in each candidate pattern 208a-208h. For example, for each of the candidate pattern 208a, 208b, 208c, 208d, 208e, 208f, 208g or 208h, crosstalk may be estimated or calculated between a first of the signal interconnects 204 and each of the remaining ones of the signal interconnects 204. Crosstalk may then be estimated or calculated between a second of the signal interconnects 204 in the candidate pattern 208a, 208b, 208c, 208d, 208e, 208f, 208g or 208h and each of the remaining ones of the signal interconnects 204 (typically excluding a further estimation or calculation with respect to the first of the interconnects 204), and so on until crosstalk is estimated between each pair of signal interconnects in the candidate pattern 208a, 208b, 208c, 208d, 208e, 208f, 208g or 208h.

In some embodiments, a crosstalk characteristic associated with each candidate pattern 208a-208h may be expressed as the maximum of the crosstalk calculated or estimated between all pair of the signal interconnects 204 in the candidate pattern 208a-208h. Typically, the crosstalk characteristic associated with each candidate pattern 208a-208h may be expressed as the maximum crosstalk calculated or estimated between adjacent pairs of the signal interconnects 204 in the candidate pattern 208a-208h, under the assumption or determination that crosstalk between non-adjacent pairs of the signal interconnects 204 is significantly reduced with respect to crosstalk between adjacent pairs of the signal interconnects 204 because of the increased distances separating non-adjacent pairs of the signal interconnects 204.

The crosstalk characteristic associated with each candidate pattern 208a-208h may be expressed as one or more of power, voltage, or current flow levels of crosstalk generated by a first of the signal interconnects 204 and/or observable or measurable in a second of the signal interconnects 204. The crosstalk between two or more of the signal interconnects 204 may be determined by estimating or calculating capacitive, inductive and/or resistive coupling between the two or more of the signal interconnects 204. Crosstalk may be calculated using a simplified model, in which bumps, posts, balls and/or vias may be characterized as cylindrical interconnects between two infinite planes such that inductive coupling between interconnects is dominant.

A crosstalk characteristic ascertained for each of the candidate patterns 208a-208h may be identified with the highest crosstalk interconnect of the signal interconnects 204 in the candidate pattern 208a-208h. The highest crosstalk interconnect of the signal interconnects 204 in a candidate pattern 208a-208h may generate greatest crosstalk within the set of interconnects 202, or be afflicted by the greatest crosstalk within the set of interconnects 202. Crosstalk levels associated with the highest crosstalk interconnect of the signal interconnects 204 may be used as a metric to characterize the corresponding candidate pattern 208a-208h. Accordingly, the candidate pattern 208a-208h selected for use in the design of an IC may have the minimum highest crosstalk interconnect from among the highest crosstalk interconnects of all candidate patterns 208a-208h.

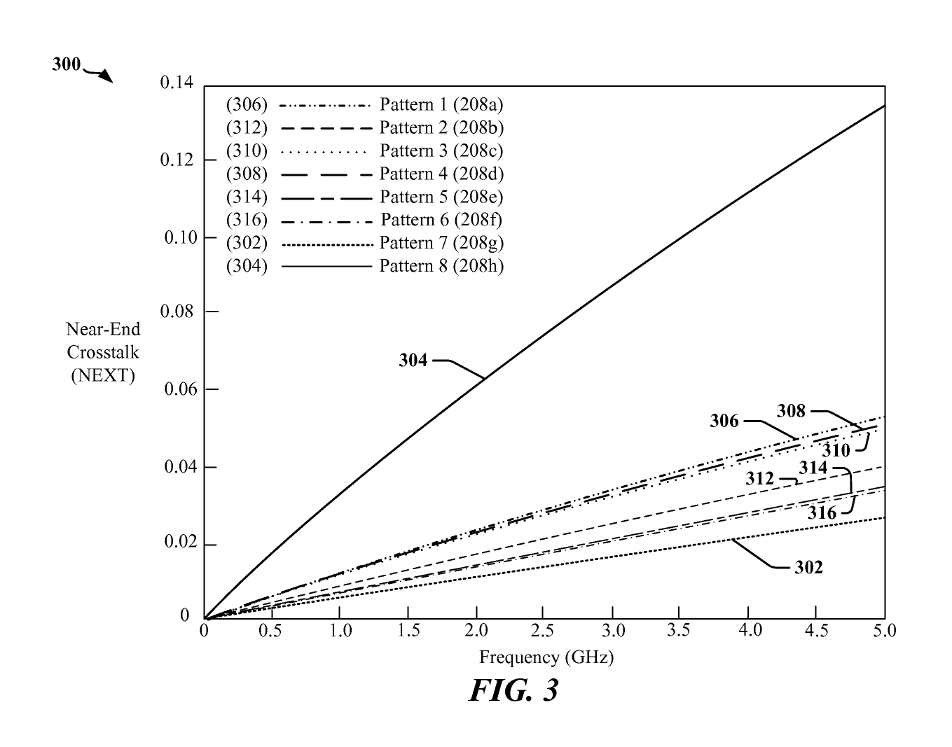

FIG. 3 is a graphical representation 300 illustrating near-end crosstalk (NEXT) across a frequency range for the highest crosstalk interconnect for each of the candidate patterns 208a-208h, with each curve (including first curve 302 and second curve 304) representing a different one of the candidate patterns 208a-208h. As illustrated, the minimum crosstalk across all frequencies is observed in the first curve 302 and the maximum crosstalk across all frequencies is observed in the second curve 304. Crosstalk levels may vary linearly with frequency or nearly linearly with frequency, as shown in FIG. 3. In some embodiments, selection of an interconnect pattern may be based on the estimated or calculated crosstalk at different selected frequencies or across all frequencies in a band of frequencies. In one example, crosstalk at different or discrete frequencies may be compared when a pair of the signal interconnects 204 are expected to carry signals having different frequencies of operation.

Referring again to the scalable process for optimizing crosstalk between interconnects 202 shown in the example in FIG. 2, crosstalk may be optimized by minimizing the maximum crosstalk associated with one of the signal interconnects 204 in the illustrated candidate patterns 208a-208h. As noted, the process may include generating all 4,368 possible interconnect patterns and identifying the highest crosstalk interconnect in each of the 4,368 possible interconnect patterns, including the illustrated candidate patterns 208a-208h. According to the example depicted in FIG. 3, candidate pattern 208g is associated with the lowest maximum crosstalk between interconnects within the candidate pattern 208g, as indicated by the curve 302. Accordingly, the candidate pattern 208g may be identified as a preferred pattern for use in designing an IC, or components related thereto, including substrates, chip carriers and circuit boards.

In some embodiments, a plurality of preferred or optimal patterns may be identified after all possible interconnect patterns have been analyzed sequentially. In one example, the candidate patterns 208a-208h may represent eight optimal patterns based on a combination of crosstalk characteristics and layout constraints imposed by design requirements. The first interconnect pattern analyzed of all possible interconnect patterns may initially be identified as the primary candidate to be compared with a next one of the interconnect patterns. When a current interconnect pattern is determined to have lower maximum interconnect crosstalk than the primary candidate, the current interconnect pattern may become the primary candidate. In one example, a plurality of candidates may be maintained for further consideration, where the plurality of candidates includes the illustrated candidate patterns 208a-208h. In some embodiments, a crosstalk characteristic is recorded for each of the possible interconnect patterns, where the crosstalk characteristic includes an estimated or calculated maximum crosstalk between interconnects and an identification of the highest crosstalk interconnect and/or pair of interconnects in the pattern.

In some embodiments, other information related to measured or estimated crosstalk levels between two or more signal interconnects in a pattern may be maintained and may be considered when selecting an interconnect pattern for inclusion in an IC design or in components related thereto, including substrates, chip carriers and circuit boards. In one example, crosstalk levels estimated or calculated for multiple pairs of interconnects may be maintained and/or considered. In another example, an interconnect pattern may be selected based on crosstalk statistics including one or more of average crosstalk between interconnects, variance, maximum crosstalk to minimum crosstalk ratio, etc. In another example, an interconnect pattern may be selected based on a comparison of maximum crosstalk estimated and/or calculated at a plurality of different frequencies. In certain embodiments, a shortlist of candidates may be considered when selecting an interconnect pattern for an IC design. After selecting a preferred or best pattern from all possible or viable interconnect patterns, interconnects may be formed on a substrate accordance with the preferred or best pattern.

With continued reference to FIGS. 2 and 3, in one example, candidate patterns 208a-208h may be examined to determine which candidate pattern 208a-208h has a highest interconnect crosstalk that is the minimum highest interconnect crosstalk of all 4,368 possible interconnect patterns. For the purposes of this description, it will be assumed that one or more of the candidate pattern 208a-208h are to be considered for use in the design of a semiconductor device or components related thereto, including substrates, chip carriers and circuit boards. As illustrated in the crosstalk response curves 302, 304, 306, 308, 310, 312, 314, and 316 corresponding to candidate patterns 208a-208h, the interconnect pattern 208g has the highest crosstalk interconnect which exhibits the lowest maximum crosstalk of all of the eight candidate patterns 208a-208h. Pattern 208g corresponds to the curve 302 shown in graph 300 of FIG. 3. The selection techniques and approaches described herein may be applied to set of interconnects 202 that includes arbitrary numbers of signal interconnects 204 and/or power/ground interconnects 206, and the techniques and approaches may be used with square, rectangular, interstitial, and hexagonal or other shapes of interconnect patterns.

In certain embodiments, multiple instances of the selected interconnect pattern 208g may be used on one or more surfaces of a semiconductor substrate, die and/or circuit board. One or more of the instances of the selected interconnect pattern 208g may be rotated with respect to other instances of the selected interconnect pattern 208g. A secondary pattern may be generated using the selected interconnect pattern 208g as a base pattern, whereby the secondary pattern includes multiple instances of selected interconnect pattern 208g that may be rotated, mirrored or non-rotated (i.e., copies). The secondary pattern can then be used to form interconnects on a substrate, chip carrier and/or circuit board. In one example, the secondary pattern may combine sufficient copies of the selected interconnect pattern 208g to enable use in connection with a 72-bit SDRAM data interface.

The selection of a preferred or optimum pattern 208g may be based on estimated or calculated crosstalk between multiple instances of sets of interconnects 202 formed based on the selected interconnect pattern 208g. For example, the interconnect in the signal interconnects 204 that is associated with the highest crosstalk in selected interconnect pattern 208g may be located near an edge of the area covered by interconnect pattern 208g, and higher than anticipated crosstalk may be experienced between two instances of sets of interconnects 202 arranged according to the interconnect pattern 208g. Accordingly, selection of the interconnect pattern 208g may be based in part on location within the interconnect pattern 208g of the interconnect in the signal interconnects 204 that is associated with the highest crosstalk, and options for aligning neighboring instances of sets of interconnects 202 formed in accordance with the interconnect pattern 208g.

In some embodiments, the interconnect pattern 208g may be associated with a process for aligning multiple instances of sets of interconnects 202 formed in accordance with the interconnect pattern 208g. For example, a first instance of a set of interconnects 202 in what may be referred to as a “cell” may be provided on a substrate with one or more other adjacent cells that are formed such that the cells may share a common border and/or be considered to be neighboring cells. The neighboring cells may be direct copies, mirror versions and/or rotated version of the first cell. The determination of orientation (i.e., angle of rotation) and mirroring of neighboring cells may be made for each edge of the first cell, and may be based on the estimation and/or calculation processes used for pairs of the signal interconnects 204 within a single pattern described elsewhere herein. In some embodiments, optimized crosstalk performance may be obtained through the use of one of the other candidate patterns 208a-208f, or 208h when the pattern is to be replicated on a substrate. Accordingly, some embodiments select an initial preferred pattern 208g from substantially all possible patterns, and perform a second estimation process to determine which of the candidate patterns 208a-208h (for example) offer the best crosstalk performance when replicated in multiple instances on a substrate.

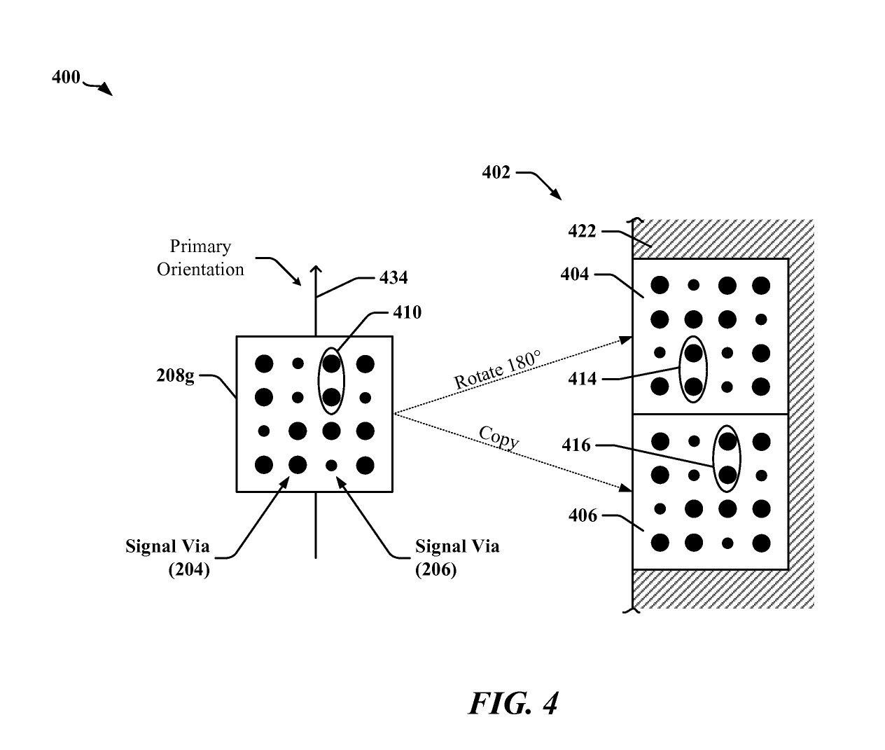

FIG. 4 is a schematic 400 illustrating simple example in which multiple instances 404 and 406 of selected interconnect pattern 208g are deployed in a semiconductor device 402. The selected interconnect pattern 208g may be an interconnect pattern that has a lowest crosstalk among all possible interconnect patterns for different arrangements of a plurality of N signal and power/ground interconnects. In the example of a data interface for SDRAM, the selected interconnect pattern 208g may provide an interconnect pattern for an 8 bit data path (i.e., a byte) with control signal interconnects, power interconnects and ground interconnects, and the selected interconnect pattern 208g may be replicated a number of times to obtain a desired data word size.

Semiconductor device 402 may comprise a substrate, chip carrier, die and/or circuit board (collectively referred to here as substrate 422) with an interconnect pattern formed on a first surface thereon. The interconnect pattern may define locations of one or more bumps, balls, posts, and/or vias. In one example, vias may interconnect with a transistor circuit formed in a layer of a semiconductor device. The interconnect pattern may comprise a plurality of sections 404 and 406. Each section may have an interconnect pattern corresponding to selected or preferred interconnect pattern 208g, which may have been determined to have a highest interconnect crosstalk that is lower than the highest interconnect crosstalk of all possible patterns. Interconnect pattern 208g may comprise N total interconnects, including signal and power/ground interconnects. Interconnect pattern 208g may be replicated on multiple substrate sections. In one example, a pair of interconnects 410 may be associated with the largest crosstalk between interconnects in pattern 208g. Instances 404 and 406 may be based on versions of pattern 208g that are rotated with respect to one another to minimize crosstalk associated with interconnect pairs 414 and 416. In some embodiments, instances 404 and 406 may be based on versions of pattern 208g that are rotated with respect to one another for other reasons, including facilitating device design specifications.

One or more instances of interconnect pattern 208g provided on substrate 422 may be rotated with respect to a primary orientation 434 of interconnect pattern 208g and relative to other instances of interconnect pattern 208g provided on substrate 422. In the example shown in FIG. 4, the selected interconnect pattern 208g may be deployed with different orientations in two adjacent sections 404 and 406. As depicted, section 406 has a direct copy of interconnect pattern 208g, while interconnect pattern 208g is rotated by 180° with respect to the primary orientation 434 in section in section 404, as can be seen from the locations 414 and 416 of the pairing of signal interconnections corresponding to the pairing 410 in pattern 208g.

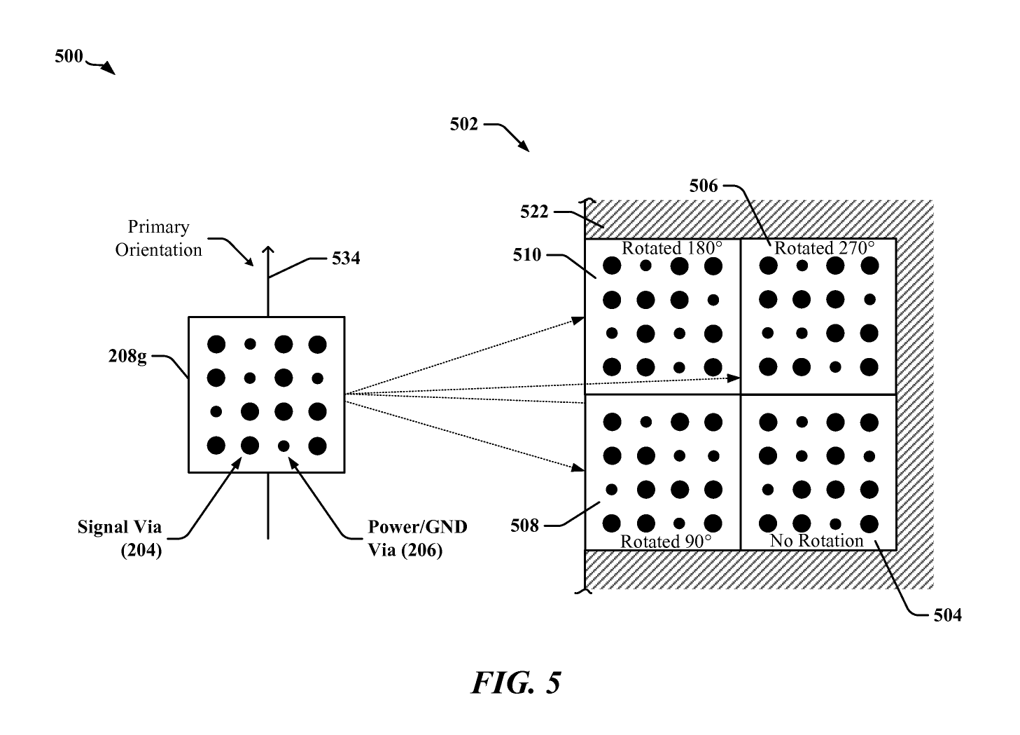

FIG. 5 is a second example 500 illustrating the use of multiple instances of a base interconnect pattern 208g. In the example, four sections 504, 506, 508, and 510 are provided in a substantially square arrangement on substrate 522 and each section 504, 506, 508, and 510 is patterned with the selected interconnect pattern 208g. The pattern in section 504 is a direct copy of the selected interconnect pattern 208g. Each of sections 506, 508, and 510 employs a rotated copy of the selected interconnect pattern 208g. In the example depicted in FIG. 5, section 506 has a 270° clockwise rotation with respect to primary orientation 534, section 508 has a 90° clockwise rotation with respect to primary orientation 534, and section 510 has a 180° clockwise rotation with respect to primary orientation 534. It will be appreciated that sections 504 and 506 form a first group, and sections 508 and 510 form a second group, which has an identical pattern as the first group, but with a 180° rotation.

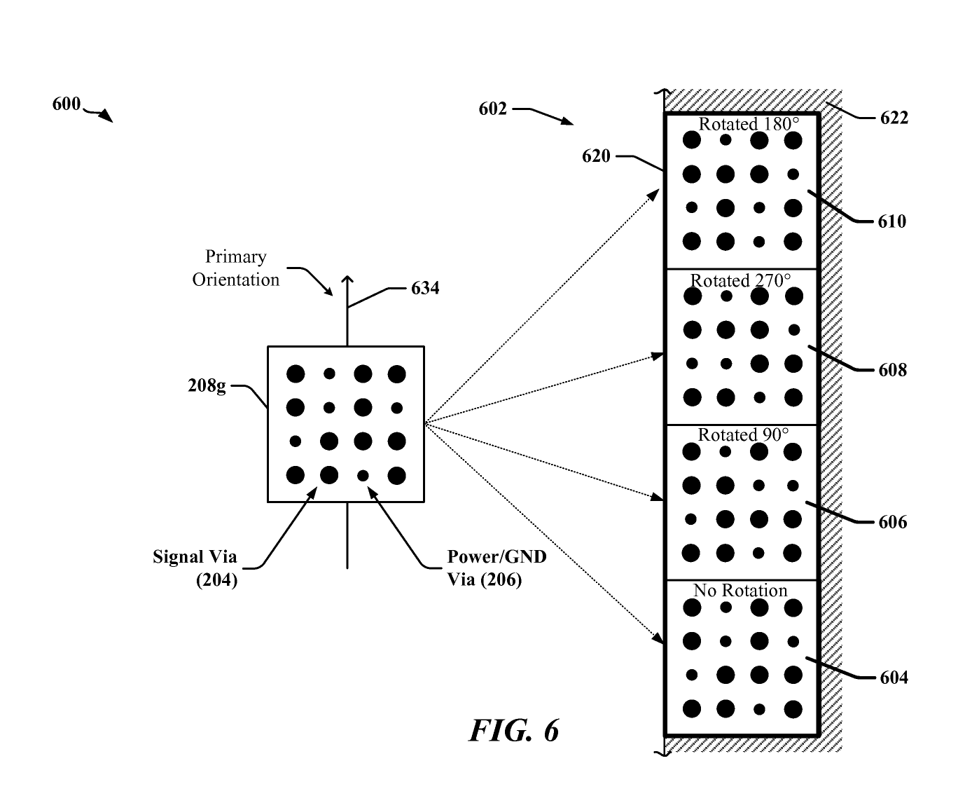

FIG. 6 is a third example 600 illustrating the use of multiple instances of a base interconnect pattern 208g. A plurality of interconnects is disposed within a substantially rectangular area 620 of substrate 622. The rectangular area 620 comprises four sections 604, 606, 608, and 610. The interconnects in each section 604, 606, 608, and 610 conform to a version of the selected interconnect pattern 208g. The pattern in section 604 is a direct copy of the selected interconnect pattern 208g. Each section 606, 608, and 610 employs a rotated copy of the selected interconnect pattern 208g, whereby section 606 has a 90° clockwise rotation with respect to primary orientation 634, section 608 has a 270° clockwise rotation with respect to primary orientation 634, and section 610 has a 180° clockwise rotation with respect to primary orientation 634. It will be appreciated that sections 604 and 606 form a first group, and sections 608 and 610 form a second group, which has an identical pattern as the first group, but with a 180° rotation.

The examples depicted in FIGS. 4, 5 and 6 are provided for illustrative reasons only. The interconnect pattern 208g may be provided in any desired rotation in any section on substrate 422, 522, or 622. In some embodiments, rotation of interconnect pattern 208g in a specific section may be determined based on characteristics of signals transmitted through vias in one or more adjacent cells.

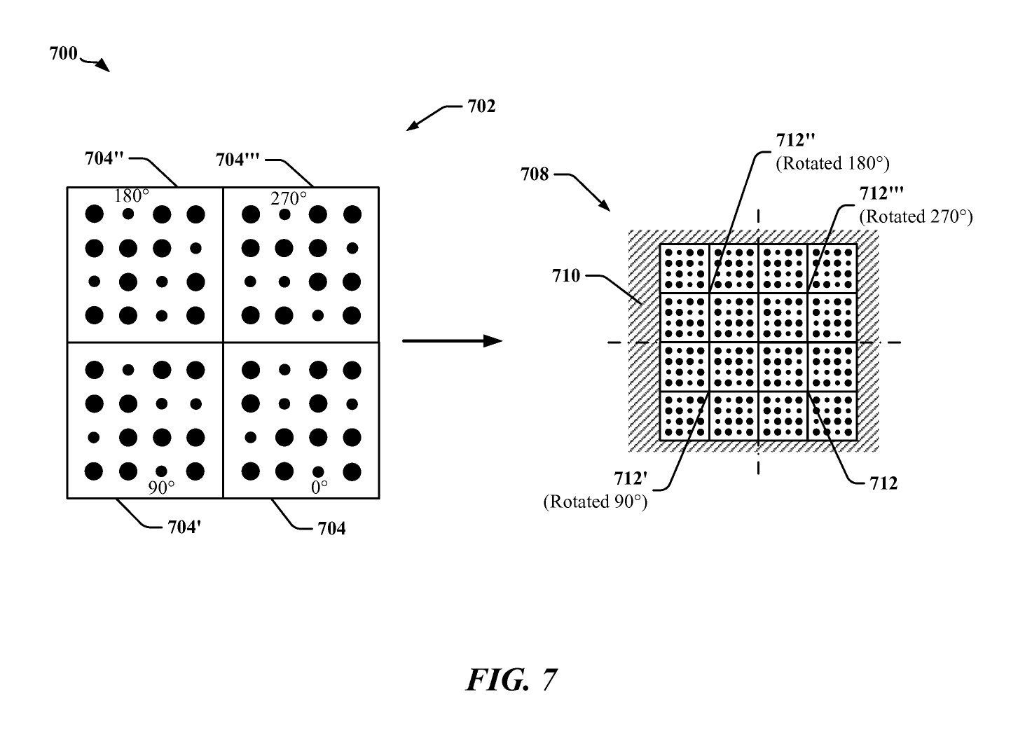

FIG. 7 is a block schematic 700 illustrating the scalability of certain aspects described herein. FIG. 7 illustrates an example in which multiple versions 704, 704′, 704″ and 704′″ of an optimized base pattern, such as pattern 208g, may be assembled to obtain a larger optimized pattern 702. The pattern 702 may be used to arrange vertical interconnects on a substrate 710. In one example, four sets of vertical interconnects 712, 712′, 712″ and 712′″ may be formed on the substrate 710 using versions of the pattern 702. The resulting arrangement of vertical interconnects 708 may be repeated on the substrate 710 for groups of similar signals, such as address or data lines used with a memory device in a computing system. Other patterns may be developed to organize and arrange groups of similar signals in quantities of 8, 16, 32, 48 and/or 64, etc.

According to certain aspects described herein, the pattern 702 may be optimized as discussed in relation to FIGS. 5 and 6, for example. The pattern 702 may be formed using a plurality of versions 704, 704′, 704″ and 704′″ of the base pattern 208g, which may have been determined or calculated to minimize maximum crosstalk for a set of vertical interconnects as discussed in relation to FIG. 2. As illustrated in FIGS. 5 and 6, different configurations of signals may be supported using multiple versions of the base pattern 208g. Some of the versions 704, 704′, 704″ and 704′″ of the base pattern 208g may be rotated with respect to one another, with respect to an axis of the base pattern 208g, and/or with respect to a common axis or orientation.

In the example depicted in FIG. 7, the pattern 702 may include one version 704 of the base pattern 208g that is unmodified, another version 704′ of the base pattern 208g that is rotated by 90°, another version 704″ of the base pattern 208g that is rotated by 180°, and another version 704′″ of the base pattern 208g that is rotated by 270°. This configuration is provided by way of example, and other applications may include different combinations of rotated, and/or mirrored versions of the base pattern 208g in the pattern 702. The versions 704, 704′, 704″ and 704′″ of the base pattern 208g may have an orientation, rotation and/or mirroring that is selected to minimize the maximum crosstalk between sets of vertical interconnects formed using the pattern 702.

The pattern 702 may be used to arrange sets of interconnects 712, 712′, 712″ and 712′″ formed on the substrate 710. In the arrangement 708 depicted, one set of interconnects 712 may be formed on the substrate 710 in accordance with an unmodified copy of the pattern 702, another set of interconnects 712′ may be formed on the substrate 710 in accordance with a version of the pattern 702 that is rotated by 90°, another set of interconnects 712″ may be formed on the substrate 710 in accordance with a version of the pattern 702 that is rotated by 180°, and another set of interconnects 712′″ may be formed on the substrate 710 in accordance with a version of the pattern 702 that is rotated by 270°. Other combinations of rotated, and/or mirrored versions of the pattern 702 may be used to generate different arrangements of vertical interconnects.

In the arrangement of interconnects 708, versions 712, 712′, 712″ and 712′″ of the pattern 702 may have an orientation, rotation and/or mirroring that is selected to minimize the maximum crosstalk between sets of vertical interconnects 712, 712′, 712″ and 712′″, which are formed on the substrate 710. Maximum crosstalk may be calculated or estimated for all combinations of location, orientation and mirroring of the pattern 702 to determine an optimal configuration of the arrangement 708. The optimized pattern 708 may then be used to form multiple sets of vertical interconnects 712, 712′, 712″ and 712′″ on the substrate 710.

Certain aspects described herein are scalable. For example, and as discussed in relation to certain examples described herein, an 8-bit base pattern 208g may be optimized and used to obtain a 32-bit pattern 702 used for creating sets of vertical interconnects 712, 712′, 712″ and 712′″ on the substrate 710. A larger pattern based on the optimized arrangement 708 of the sets of vertical interconnects 712, 712′, 712″ and 712′″ may be developed as a template or pattern for even larger numbers of vertical interconnects.

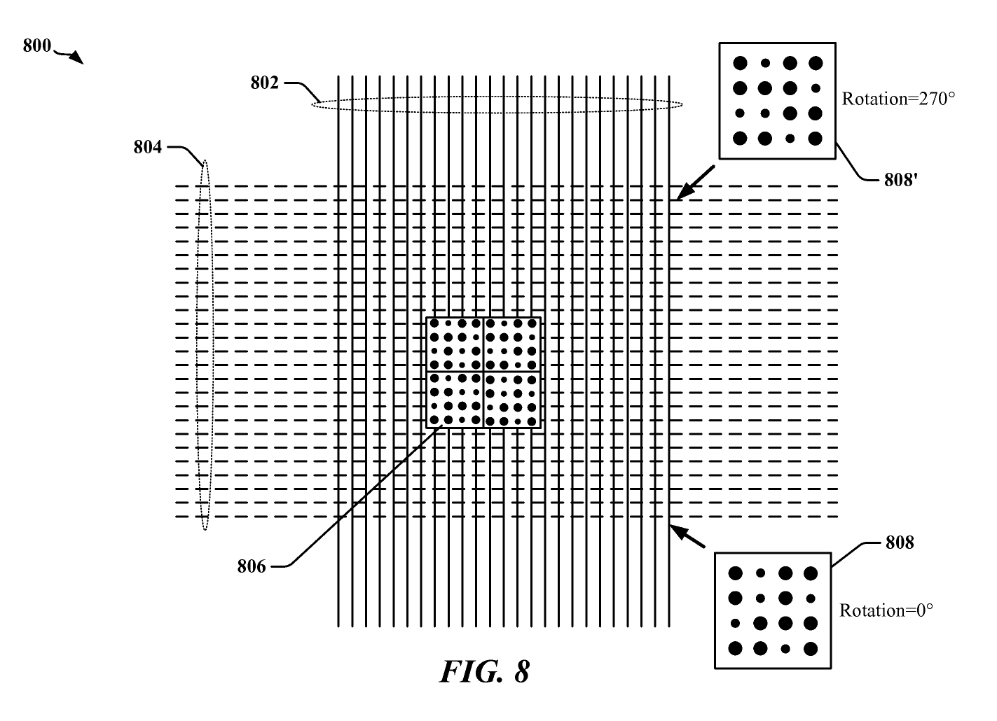

With reference to FIG. 8, crosstalk may be further optimized by considering interactions between horizontal interconnects 802 and 804 and vertical interconnects 806. While a plurality of patterns may be employed in an arrangement of vertical interconnects, a single base pattern 808 is used in the example depicted in FIG. 8. Pattern 808 is based on the example pattern 208g of FIG. 2, and pattern 808′ is a rotated version of the base pattern 808. The pattern 808′ may be rotated or mirrored to minimize crosstalk between sets of vertical interconnects, as disclosed herein. In the example, vertical interconnects 806 may be formed using three instances of pattern 808 and one instance of the rotated/mirrored pattern 808′. In some examples, the pattern 808′ may comprise a different base pattern instead of a mirrored or rotated copy of the base pattern 808.

The vertical interconnects 806 may be located in close proximity to certain of the horizontal interconnects 802 and 804 and some of the vertical interconnects 806 may be connected to corresponding horizontal interconnects 802 and 804. Crosstalk may occur between vertical interconnects 806 and horizontal interconnects 802 and 804. Accordingly, certain embodiments may optimize the arrangement of vertical interconnects 806 with respect to the horizontal interconnects 802 and 804, and vice versa, for use in a chip carrier, circuit board, substrate, or the like. Optimization may be accomplished based on calculations of the effects of electromagnetic interactions between vertical interconnects 806 and intersecting or proximately located horizontal interconnects 802 and 804.

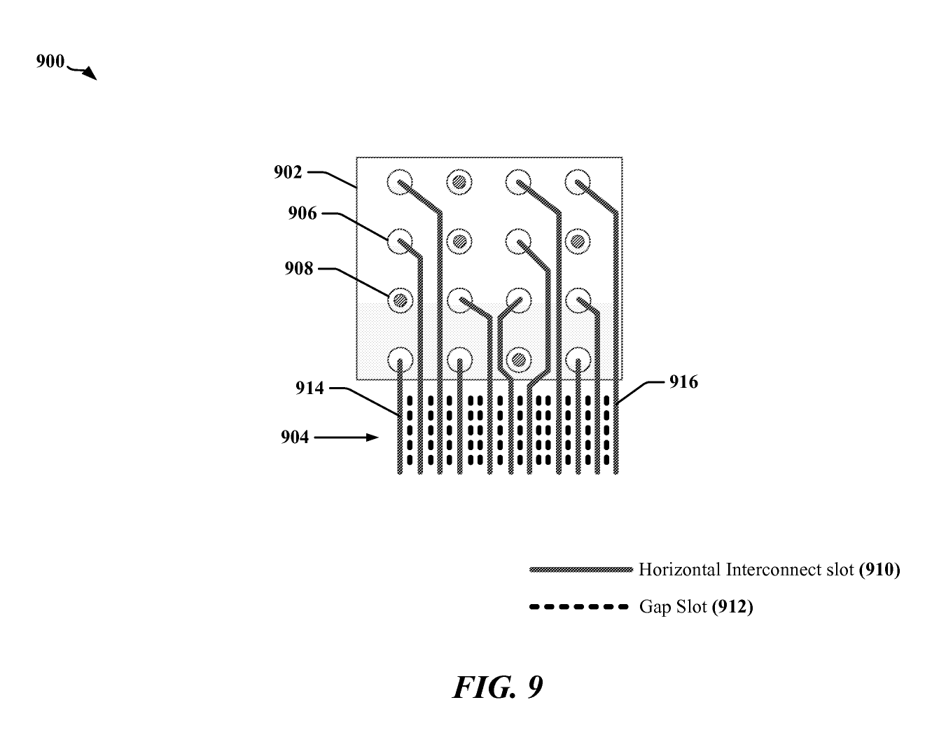

FIG. 9 is a schematic diagram 900 illustrating the use of horizontal interconnects 904 on a layer of a substrate, circuit board, chip-carrier or the like. The horizontal interconnects 904 may be provided in horizontal interconnect slots 910 and certain pairs of the horizontal interconnect slots 910 may be separated from one another by one or more gap slots 912. The one or more horizontal interconnect slots 910 may include signal conductors that carry signals to and from a set of vertical interconnects 902. Unused and/or unconnected traces, an insulator or another filler may be provided in the one or more gap slots 912. One or more of the gap slots 912 may be left vacant. The assignment of signals to the set of vertical interconnects 902 may be determined by structures and constraints of an integrated circuit, connector, circuit board and so on. The set of vertical interconnects 902 may include interconnects such as vertical interconnect 906 that carries a signal between devices and/or connectors. The set of vertical interconnects 902 may include one or more power, ground and/or other vertical interconnects 908 that may not be connected on the illustrated layer.

In the depicted example 900, the set of vertical interconnects 902 may be formed in accordance with an optimized vertical interconnect pattern. In the example 900, the horizontal interconnects 904 may be used to fan out 11 signals. Power and ground signals may be connected to one or more different layers using vias 908. The specific location of the signals, power and ground on the optimized set of vertical interconnects 902 may dictate, to some degree, the location of the horizontal interconnect slots 910 and/or gap slots 912. The configuration and number of signals to be carried in the set of vertical interconnects 902 results in 12 gap slots 912 remaining between outer horizontal interconnects 914 and 916 (as indicated by broken lines). The placement of the horizontal interconnect slots 910 may generate crosstalk, or be susceptible to crosstalk between horizontal interconnects 904 and/or between horizontal interconnects 904 and vertical interconnects 902. The placement of gap slots 912 and/or interconnect slots 910 based on placement of vertical interconnects 902 may conflict with an optimal or preferred layout pattern for the set of horizontal interconnects 904. Accordingly, a previously selected arrangement of horizontal interconnect slots 910 and gap slots 912 and/or vertical interconnects 902 may not be achievable.

Tradeoffs and/or co-optimizations may be employed to obtain an optimized combination of horizontal interconnects 904 and vertical interconnects 902 across one or more planes. In one example, a horizontal interconnect pattern may determine placement of one or more vias and corresponding vertical interconnects, and may thereby eliminate an optimum vertical interconnect pattern from consideration for use on the chip carrier. In such a case, co-optimization might be required. In one example of a co-optimization process, different combinations of vertical interconnect patterns with horizontal interconnect patterns may be considered and an optimal combination of horizontal and vertical patterns may be selected to obtain a combination that is associated with a lowest crosstalk in one or more bottleneck interconnects. The bottleneck interconnects may correspond to horizontal or vertical interconnects. In another example, the horizontal interconnect may be the source of the majority of system crosstalk issues. The best horizontal interconnect pattern may be selected before a compatible associated vertical interconnect pattern is selected. In another example, the vertical interconnect may be the source of a majority of the system crosstalk, in which case the best vertical interconnect pattern may be selected and an associated horizontal interconnect pattern compatible with the chosen vertical interconnect pattern may then be selected.

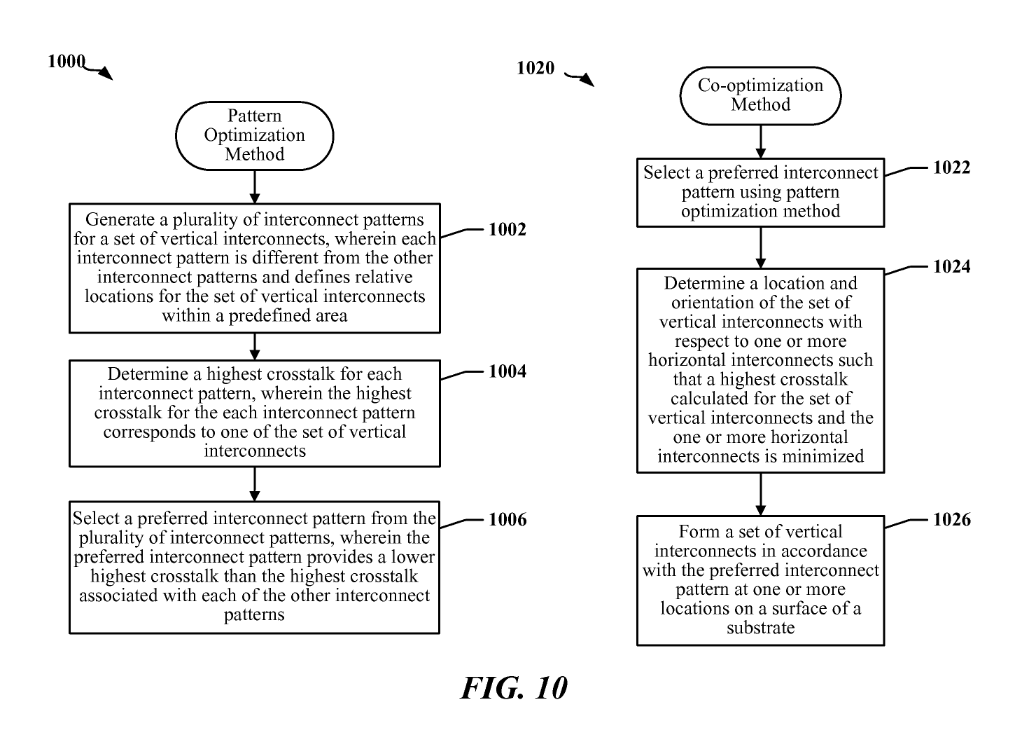

FIG. 10 includes a flowchart 1000 illustrating a method for pattern optimization. The patterns may define relative placements of vertical interconnects on a semiconductor device, a chip carrier, a substrate and/or a circuit board. At step 1002, a plurality of interconnect patterns is generated for a set of vertical interconnects. The set of vertical interconnects may comprise a first plurality of interconnects configured to transmit signals between first and second layers of the semiconductor device. The set of vertical interconnects may comprise a second plurality of interconnects configured to interconnect ground planes of the first and second layers, or power supplies of the first and second layers. The set of vertical interconnects may comprise a total of N interconnects or interconnect sites. N may be greater than two (2) interconnects. In one example, N=16 interconnects. The N interconnects in the set of interconnects may be arranged in an I×J pattern and, in one example, the set of vertical interconnects may be arranged in a 4×4 interconnect pattern or a 5×5 interconnect pattern. The plurality of N interconnects in the interconnect patterns may be equally spaced. Each interconnect pattern may be different from the other interconnect patterns. Each interconnect pattern may define relative locations for the set of vertical interconnects within a predefined area. Two interconnect patterns may be considered to be different from one another when the two interconnect patterns define a different relative location for at least one of the first plurality of interconnects. Each of the second plurality of interconnects may be considered identical to one another.

According to certain aspects described herein, the number of interconnect patterns generated is determined as a function of the number of first plurality of interconnects. For example, the plurality of interconnect patterns may comprise all permutations of placement of the first plurality of interconnects within the predefined area. The number of permutations may be calculated under the assumption that power and ground vertical interconnects may be treated as identical and/or equivalent interconnects. The set of vertical interconnects may be evenly distributed within the predefined area.

At step 1004, a highest crosstalk is determined for each of the interconnect patterns. The highest crosstalk may correspond to one of the set of vertical interconnects or a pair of the vertical interconnects. The highest crosstalk for each of the interconnect patterns may be determined for a plurality of frequencies. The highest crosstalk for each of the interconnect patterns may be determined for a range of frequencies.

At step 1006, an interconnect pattern is selected from the plurality of interconnect patterns. The selected interconnect pattern may provide a lower or minimum highest crosstalk relative to the highest crosstalk associated with each of the other interconnect patterns.

According to certain aspects described herein, a set pattern may be developed based on calculated, estimated and/or measured crosstalk between sets of the vertical interconnects, when each set of vertical interconnects is arranged according to a preferred interconnect pattern. The set pattern may define a configuration for a plurality of sets of vertical interconnects, including one or more of a rotation of one or more sets of vertical interconnects and whether one or more set of vertical interconnects is mirrored. The set pattern may be selected to minimize a highest crosstalk calculated between pairs of sets of vertical interconnects in the plurality of sets of vertical interconnects.

FIG. 10 also includes a flowchart 1020 illustrating a method for forming patterns using a preferred pattern generated according to the method illustrated in the pattern optimization flowchart 1000. At step 1022, a preferred interconnect pattern is selected where the preferred interconnect pattern provides a lower highest crosstalk than the highest crosstalk associated with each of the other interconnect patterns.

At step 1024, a location and orientation of the set of vertical interconnects may be determined with respect to one or more horizontal interconnects such that a highest crosstalk calculated for the set of vertical interconnects and the one or more horizontal interconnects is minimized.

At step 1026, a set of vertical interconnects is formed in accordance with the preferred interconnect pattern at one or more locations on a surface of a substrate.

According to certain aspects described herein, the highest crosstalk for each of the interconnect patterns is determined as the highest crosstalk between two or more of the plurality of sets of interconnects. At least one set of interconnects may be rotated to obtain a minimum highest crosstalk between the two or more sets of interconnects. According to certain aspects described herein, a combination of the preferred interconnect pattern with a pattern of collocated horizontal interconnects provides a lower highest crosstalk than a highest crosstalk provided by combinations of the other interconnect patterns with patterns of collocated horizontal interconnects.

According to certain aspects described herein, the highest crosstalk for each of the interconnect patterns may be determined by modeling the set of vertical interconnects as a plurality of cylindrical interconnects between two infinite planes, and calculating crosstalk between pairs of the cylindrical interconnects.

According to certain aspects described herein, the crosstalk may be calculated by calculating crosstalk between each pair of the cylindrical interconnects when both cylindrical interconnects correspond to vertical interconnects configured to transmit signals between first and second layers of the semiconductor device. Calculations related to crosstalk between the each pair of the cylindrical interconnects may be avoided when one of the cylindrical interconnects corresponds to a vertical interconnects configured to interconnect ground planes of the first and second layers, or power supplies of the first and second layers.

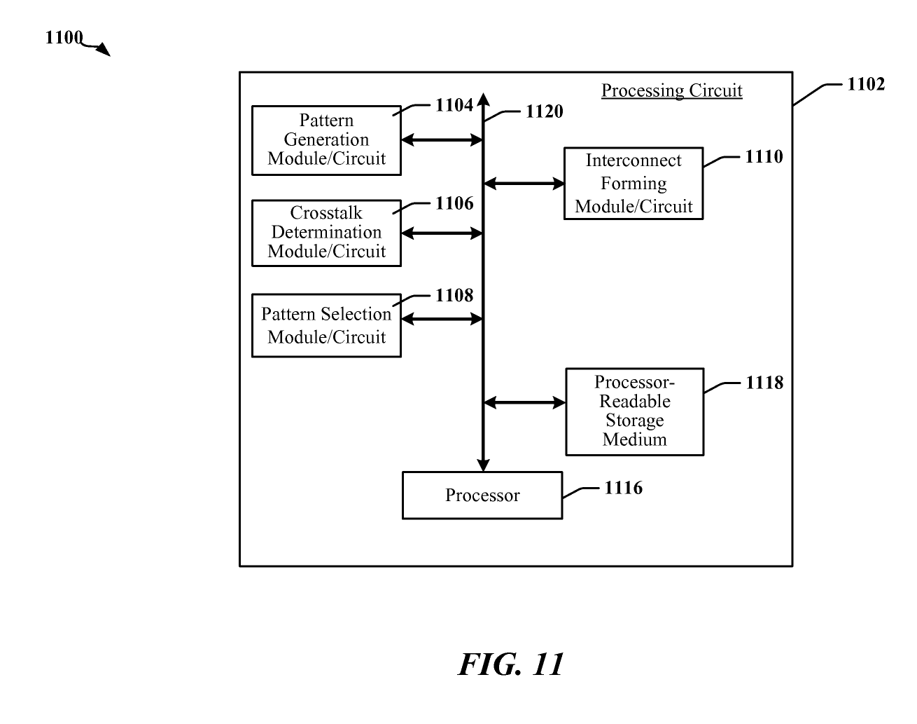

FIG. 11 is a conceptual block diagram illustrating an example of a hardware implementation for an apparatus 1100 employing a processing circuit 1102. The processing circuit 1102 may be implemented with a bus architecture, represented generally by the bus 1120. The bus 1120 may include any number of interconnecting buses and bridges depending on the specific application of the processing system 1102 and the overall design constraints. The bus 1120 links together various circuits including one or more processing devices and/or hardware modules, represented by the processor 1116, the modules/circuits 1104, 1106, 1108, 1110 and the processor-readable storage medium 1118. The bus 1120 may also link various other circuits such as timing sources, peripherals, voltage regulators, and power management circuits, which are well known in the art, and therefore, will not be described any further.

The processing system 1102 may include the processor 1116 coupled to the processor-readable storage medium 1118. The processor 1116 is responsible for general processing, including the execution of software stored on the processor-readable storage medium 1118. The software, when executed by the processor 1116, causes the processing system 1102 to perform the various functions described supra for any particular apparatus 1100. The processor-readable storage medium 1118 may also be used for storing data that is manipulated by the processor 1116 when executing software. The processing system 1102 further includes at least one of the modules/circuits 1104, 1106, 1108 and 1110. The modules 1104, 1106, 1108 and 1110, may comprise software modules executed by the processor 1116, resident/stored in the processor-readable storage medium 1118, one or more hardware modules coupled to the processor 1116, or some combination thereof.

In one configuration, an apparatus 1100 for wireless communication includes means 1104 for generating a plurality of interconnect patterns for a set of vertical interconnects, means 1106 determining a highest crosstalk for each of the interconnect patterns, means 1108 for selecting a preferred interconnect pattern from the plurality of interconnect patterns, means 1110 for means for forming a set of vertical interconnects at one or more locations on a surface of a substrate. In one example, the means 1106 for determining a highest crosstalk for the interconnect patterns may determine the highest crosstalk for each of a plurality of frequencies or bands of frequencies and the means 1108 for selecting a preferred interconnect pattern from the plurality of interconnect patterns may select the interconnect pattern that provides a lower or minimum highest crosstalk relative to the highest crosstalk associated with each of the other interconnect patterns.

The aforementioned means may be one or more of the aforementioned modules of the apparatus 1100 and/or the processing system 1102 configured to perform the functions recited by the aforementioned means.

The terms wafer and substrate may be used herein to include any structure having an exposed surface with which to form an IC according to aspects of the present disclosure. The term “die” may be used herein to include an IC. A die may include one or more circuits. The term substrate is understood to include semiconductor wafers. The term substrate is also used to refer to semiconductor structures during fabrication, and may include other layers that have been fabricated thereupon. The term substrate includes doped and undoped semiconductors, epitaxial semiconductor layers supported by a base semiconductor, or semiconductor layers supported by an insulator, as well as other semiconductor structures well known to one skilled in the art.

One or more of the components, steps, features and/or functions illustrated in FIGS. 1-11 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-9 and 11 may be configured to perform and/or embody one or more of the methods, features, or steps described herein, including the methods illustrated in FIG. 10. The novel algorithms described herein may also be efficiently implemented in software and/or embedded in hardware.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine readable mediums for storing information. The terms “machine readable medium” or “machine readable storage medium” include, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits (e.g., processing circuit), elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM, flash memory, ROM, erasable programmable-ROM (EPROM), electrically erasable programmable-ROM (EEPROM), registers, hard disk, a removable disk, a compact Disk ROM (CD-ROM), or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing aspects of the disclosure are merely examples and are not to be construed as limiting the invention. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

What is claimed is:

1. A method for optimizing interconnect patterns in a semiconductor device, comprising:
generating a plurality of interconnect patterns for a set of vertical interconnects, wherein each interconnect pattern is different from the other interconnect patterns and defines relative locations for the set of vertical interconnects within a predefined area;
determining a highest crosstalk for each interconnect pattern, wherein the highest crosstalk for the each interconnect pattern corresponds to one of the set of vertical interconnects; and
selecting a preferred interconnect pattern from the plurality of interconnect patterns, wherein the preferred interconnect pattern provides a lower highest crosstalk than the highest crosstalk associated with each of the other interconnect patterns.

2. The method of claim 1, wherein the set of vertical interconnects comprises:
a first plurality of vertical interconnects configured to transmit signals between first and second layers of the semiconductor device; and
a second plurality of vertical interconnects configured to interconnect ground planes of the first and second layers, or power supplies of the first and second layers.

3. The method of claim 2, where the set of vertical interconnects comprises 16 interconnects.

4. The method of claim 3, wherein the 16 interconnects are arranged in a 4 by 4 interconnect pattern.

5. The method of claim 2, wherein two interconnect patterns are different from one another only when the two interconnect patterns define a different relative location for at least one of the first plurality of interconnects.

6. The method of claim 5, wherein the set of vertical interconnects is evenly distributed within the predefined area.

7. The method of claim 2, wherein the plurality of interconnect patterns comprises all permutations of placement of the first plurality of interconnects within the predefined area.

8. The method of claim 1, wherein the highest crosstalk for each of the interconnect patterns is determined for a plurality of frequencies.

9. The method of claim 1, wherein the highest crosstalk for each of the interconnect patterns is determined for a range of frequencies.

10. The method of claim 1, further comprising:
forming a set of vertical interconnects at one or more locations on a surface of a substrate, wherein the set of vertical interconnects formed at each location is formed in accordance with the preferred interconnect pattern.

11. The method of claim 10, wherein forming the set of vertical interconnects at the one or more locations on the surface of the substrate includes:
forming a plurality of sets of vertical interconnects at different locations on the surface of the substrate, wherein at least one set of vertical interconnects is rotated with respect to another set of vertical interconnects.

12. The method of claim 10, wherein determining the highest crosstalk for each of the interconnect patterns includes:
determining the highest crosstalk between pairs of sets of vertical interconnects formed on the substrate; and
minimizing a highest crosstalk between the pairs of sets of vertical interconnects by rotating or mirroring at least one set of vertical interconnects.

13. The method of claim 10, wherein forming the set of vertical interconnects at the one or more locations on the surface of the substrate includes:
forming a plurality of sets of vertical interconnects at different locations on the surface of the substrate according to a set pattern that defines a rotation of the each set of vertical interconnects, whether the each set of vertical interconnects is mirrored, and a location of the each set of interconnects relative to the other sets of vertical interconnects,
wherein the set pattern is selected to minimize a highest crosstalk calculated between pairs of sets of vertical interconnects in the plurality of sets of vertical interconnects.

14. The method of claim 10, wherein forming the set of vertical interconnects at the one or more locations on the surface of the substrate includes:
determining a location and orientation of the set of vertical interconnects with respect to one or more horizontal interconnects such that a highest crosstalk calculated for the set of vertical interconnects and the one or more horizontal interconnects is minimized.

15. The method of claim 1, wherein a combination of the preferred interconnect pattern with a pattern of collocated horizontal interconnects provides a lower highest crosstalk than a highest crosstalk provided by combinations of the other interconnect patterns with patterns of collocated horizontal interconnects.

16. The method of claim 1, wherein determining the highest crosstalk for each of the interconnect patterns includes:
modeling the set of vertical interconnects as a plurality of cylindrical interconnects between two infinite planes; and
calculating crosstalk between pairs of the cylindrical interconnects.

17. The method of claim 16, wherein for each pair of the cylindrical interconnects calculating the crosstalk includes:
calculating crosstalk between the each pair of the cylindrical interconnects when both cylindrical interconnects correspond to vertical interconnects configured to transmit signals between first and second layers of the semiconductor device; and
refraining from calculating crosstalk between the each pair of the cylindrical interconnects when one of the cylindrical interconnects corresponds to a vertical interconnect configured to interconnect ground planes of the first and second layers, or power supplies of the first and second layers.

18. An apparatus for optimizing interconnect patterns in a semiconductor device, comprising:
a processing system configured to:
generate a plurality of interconnect patterns for a set of vertical interconnects, wherein each interconnect pattern is different from the other interconnect patterns and defines relative locations for the set of vertical interconnects within a predefined area;
determine a highest crosstalk for each interconnect pattern, wherein the highest crosstalk for the each interconnect pattern corresponds to one of the set of vertical interconnects; and
select a preferred interconnect pattern from the plurality of interconnect patterns, wherein the preferred interconnect pattern provides a lower highest crosstalk than the highest crosstalk associated with each of the other interconnect patterns, and
a processor-readable storage medium.

19. The apparatus of claim 18, wherein the set of vertical interconnects comprises:
a first plurality of vertical interconnects configured to transmit signals between first and second layers of the semiconductor device; and
a second plurality of vertical interconnects configured to interconnect ground planes of the first and second layers, or power supplies of the first and second layers.

20. The apparatus of claim 19, where the set of vertical interconnects comprises 16 interconnects arranged in a 4 by 4 interconnect pattern.

21. The apparatus of claim 19, wherein two interconnect patterns are different from one another only when the two interconnect patterns define a different relative location for at least one of the first plurality of vertical interconnects.

22. The apparatus of claim 21, wherein the set of vertical interconnects are evenly distributed within the predefined area.

23. The apparatus of claim 19, wherein the plurality of interconnect patterns comprises all permutations of placement of the first plurality of vertical interconnects within the predefined area.

24. The apparatus of claim 18, wherein the highest crosstalk for each of the interconnect patterns is determined for a plurality of frequencies.

25. The apparatus of claim 18, wherein the highest crosstalk for each of the interconnect patterns is determined for a range of frequencies.

26. The apparatus of claim 18, wherein the processing system is configured to:
cause at least one set of vertical interconnects to be formed at one or more locations on a surface of a substrate, wherein the set of vertical interconnects is formed in each location in accordance with the preferred interconnect pattern.

27. The apparatus of claim 26, wherein at least one set of vertical interconnects is rotated with respect to another set of vertical interconnects.

28. The apparatus of claim 26, wherein the processing system is configured to:
minimize a highest crosstalk calculated between a pair of sets of vertical interconnects by rotating or mirroring one of the pair of sets of vertical interconnects.

29. The apparatus of claim 26, wherein the processing system configured to:
determine a location and orientation of the set of vertical interconnects with respect to one or more horizontal interconnects such that a highest crosstalk calculated for the set of vertical interconnects and the one or more horizontal interconnects is minimized.

30. The apparatus of claim 18, wherein a combination of the preferred interconnect pattern with a pattern of collocated horizontal interconnects provides a lower highest crosstalk than a highest crosstalk provided by combinations of the other interconnect patterns with patterns of collocated horizontal interconnects.

31. The apparatus of claim 18, wherein the processing system configured to:
model the set of vertical interconnects as a plurality of cylindrical interconnects between two infinite planes; and
calculate crosstalk between pairs of the cylindrical interconnects.

32. The apparatus of claim 31, wherein the processing system configured to:
calculate crosstalk between each pair of the cylindrical interconnects when both cylindrical interconnects correspond to vertical interconnects configured to transmit signals between first and second layers of the semiconductor device; and
refrain from calculating crosstalk between the each pair of the cylindrical interconnects when one of the cylindrical interconnects corresponds to a vertical interconnect configured to interconnect ground planes of the first and second layers, or power supplies of the first and second layers.

33. An apparatus for optimizing interconnect patterns in a semiconductor device, comprising:
means for generating a plurality of interconnect patterns for a set of vertical interconnects, wherein each interconnect pattern is different from the other interconnect patterns and defines relative locations for the set of vertical interconnects within a predefined area;
means for determining a highest crosstalk for each interconnect pattern, wherein the highest crosstalk for the each interconnect pattern corresponds to one of the set of vertical interconnects; and
means for selecting a preferred interconnect pattern from the plurality of interconnect patterns, wherein the preferred interconnect pattern provides a lower highest crosstalk than the highest crosstalk associated with each of the other interconnect patterns.

34. The apparatus of claim 33, wherein the set of vertical interconnects comprises:
a first plurality of vertical interconnects configured to transmit signals between first and second layers of the semiconductor device; and
a second plurality of vertical interconnects configured to interconnect ground planes of the first and second layers, or power supplies of the first and second layers.

35. The apparatus of claim 34, where the set of vertical interconnects comprises 16 interconnects arranged in a 4 by 4 interconnect pattern.

36. The apparatus of claim 34, wherein two interconnect patterns are different from one another only when the two interconnect patterns define a different relative location for at least one of the first plurality of vertical interconnects.

37. The apparatus of claim 36, wherein the set of vertical interconnects are evenly distributed within the predefined area.

38. The apparatus of claim 34, wherein the plurality of interconnect patterns comprises all permutations of placement of the first plurality of vertical interconnects within the predefined area.

39. The apparatus of claim 33, wherein the highest crosstalk for each interconnect pattern is determined for a plurality of frequencies.

40. The apparatus of claim 33, wherein the highest crosstalk for each interconnect pattern is determined for a range of frequencies.

41. The apparatus of claim 33, further comprising:
means for forming a set of vertical interconnects at one or more locations on a surface of a substrate, wherein the set of vertical interconnects formed in each location is formed in accordance with the preferred interconnect pattern.

42. The apparatus of claim 41, wherein the means for forming the set of vertical interconnects at the one or more locations on the surface of the substrate forms a plurality of sets of vertical interconnects at different locations on the surface of the substrate, wherein at least one set of vertical interconnects is rotated with respect to another set of vertical interconnects.

43. The apparatus of claim 42, wherein the means for determining the highest crosstalk for each of the interconnect patterns determines the highest crosstalk between two or more sets of vertical interconnects, and wherein the at least one set of vertical interconnects is rotated to obtain a minimum highest crosstalk between the two or more sets of vertical interconnects.

44. The apparatus of claim 33, wherein the means for determining the highest crosstalk for each of the interconnect patterns:
models the set of vertical interconnects as a plurality of cylindrical interconnects between two infinite planes; and
calculates crosstalk between pairs of the cylindrical interconnects.

45. The apparatus of claim 44, wherein for each pair of the cylindrical interconnects the means for determining the highest crosstalk:
calculates crosstalk between the each pair of the cylindrical interconnects when both cylindrical interconnects correspond to vertical interconnects configured to transmit signals between first and second layers of the semiconductor device; and
refrains from calculating crosstalk between the each pair of the cylindrical interconnects when one of the cylindrical interconnects corresponds to a vertical interconnect configured to interconnect ground planes of the first and second layers, or power supplies of the first and second layers.

46. The apparatus of claim 33, wherein the means for selecting the preferred interconnect pattern from the plurality of interconnect patterns selects the preferred pattern based on a location and orientation of the set of vertical interconnects with respect to one or more horizontal interconnects such that a highest crosstalk calculated for the set of vertical interconnects and the one or more horizontal interconnects is minimized.

47. The apparatus of claim 33, wherein a combination of the preferred interconnect pattern with a pattern of collocated horizontal interconnects provides a lower highest crosstalk than a highest crosstalk provided by combinations of the other interconnect patterns with patterns of collocated horizontal interconnects.

48. A non-transitory processor-readable storage medium having one or more instructions which when executed by at least one processing circuit causes the at least one processing circuit to:
generate a plurality of interconnect patterns for a set of vertical interconnects between layers of a substrate, chip carrier or circuit board, wherein each interconnect pattern is different from the other interconnect patterns and defines relative locations for the set of vertical interconnects within a predefined area;
determine a highest crosstalk for each interconnect pattern, wherein the highest crosstalk for the each interconnect pattern corresponds to one of the set of vertical interconnects; and
select a preferred interconnect pattern from the plurality of interconnect patterns, wherein the preferred interconnect pattern provides a lower highest crosstalk than the highest crosstalk associated with each of the other interconnect patterns.

49. The non-transitory processor-readable storage medium of claim 48, wherein the set of vertical interconnects comprises:
a first plurality of vertical interconnects configured to transmit signals between first and second layers; and
a second plurality of vertical interconnects configured to interconnect ground planes of the first and second layers, or power supplies of the first and second layers.

50. The non-transitory processor-readable storage medium of claim 49, wherein the plurality of interconnect patterns comprises all permutations of placement of the first plurality of vertical interconnects within the predefined area.

51. The non-transitory processor-readable storage medium of claim 48, wherein the highest crosstalk for each of the interconnect patterns is determined for a plurality of frequencies.

52. The non-transitory processor-readable storage medium of claim 48, wherein the highest crosstalk for each of the interconnect patterns is determined for a range of frequencies.

53. A semiconductor device, comprising:
a substrate;
first and second layers provided on the substrate; and
a plurality of interconnects formed between the first and second layers, wherein the plurality of interconnects includes a first set of vertical interconnects formed in accordance with an interconnect pattern, and a second set of vertical interconnects formed in accordance with a rotated version of the interconnect pattern, wherein:
the interconnect pattern is one of a plurality of interconnect patterns generated based on a number of signals interconnected by the first and second set of vertical interconnects; and
the interconnect pattern is selected from the plurality of interconnect patterns when a maximum crosstalk power estimated or calculated for the interconnect pattern is lower than maximum crosstalk powers estimated or calculated for the other interconnect patterns.

54. The semiconductor device of claim 53, wherein each set of the first and second sets of vertical interconnects comprises:
a first plurality of vertical interconnects that are configured to transmit signals between the first and second layers; and
a second plurality of vertical interconnects that are configured to interconnect ground planes of the first and second layers; and
a third plurality of vertical interconnects that are configured to interconnect power supplies of the first and second layers.

55. The semiconductor device of claim 53, wherein the interconnect pattern is selected from the plurality of interconnect patterns when a maximum crosstalk power estimated or calculated for a combination of the interconnect pattern and a pattern of collocated horizontal interconnects is lower than maximum crosstalk powers estimated or calculated for combinations of other interconnect patterns and other patterns of horizontal interconnects.
